(19) United States
(12) Patent Application Publication
(10) Pub. No.: US 2020/0291272 A1
(43) Pub. Date: Sep. 17, 2020

(54) PHOTOSENSITIVE ADHESIVE

(71) Applicant: UNITED MEGA RICH LIMITED, Hong Kong (CN)

(72) Inventor: Wei Kong Wilson MAK, Hong Kong (CN)

(21) Appl. No.: 16/755,960

(22) PCT Filed: Jan. 28, 2019
(86) PCT No.: PCT/IB2019/050665

§ 371 Date: Apr. 14, 2020

(30) Foreign Application Priority Data
Feb. 9, 2018 (HK) 18102099.6

(51) Int. Cl. C09J 9/00; C09J 183/06; C09J 175/14

(52) U.S. Cl. CPC C09J 9/00; B01F 3/18; C09J 175/14; C09J 183/06

(57) ABSTRACT

The present invention provides a photosensitive adhesive comprising a composition of 0.1 portion to 1 portion by weight of photo initiator; 0.1 portion to 3 portions by weight of organic silicone; 10 portions to 32.5 portions by weight of isocyanate; 10 portions to 32.5 portions by weight of hydroxyethyl terminated polysiloxane; 10 portions to 32.5 portions by weight of polycarbonate diol; 5 portions to 17.5 portions by weight of hydroxyethyl acrylate; 0.01 portion to 0.5 portion by weight of catalyst; and 0.01 portion to 0.5 portion by weight of polymerization inhibitor.

### TECHNICAL FIELD

The present invention relates broadly to adhesives. More specifically, the present invention relates to a photosensitive adhesive.

### BACKGROUND OF THE INVENTION

Photosensitive adhesive (also known as UV adhesive) is a type of adhesive that generally realizes adhesion under the ultraviolet light source, and it is also called photocuring adhesive. It usually comprises principal components such as base resin, reactive monomer and photo initiator, as well as assistants such as stabilizer, cross-linking agent and coupling agent. Under the irradiation of UV light with the appropriate wavelength, the photo initiator quickly generates free agents or ions, and then triggers the polymerization and cross-linking of the base resin and the reactive monomer to form a network. structure, thereby achieving the rapid 1.5 bonding of bonding materials. Existing UV adhesives are all liquid, which makes it easily contaminate unnecessary surfaces (especially for small objects) during the use, such as the user's fingers, causing waste, etc.; Besides, existing UV adhesives do not adhere well to surfaces that require curing adhesion before curing. If there is relative movement between the two surfaces that need to be cured and bonded in the curing process, the overall surface tends to be smeared with UV adhesives, causing inconvenience and waste. UV adhesives cure fast, so the position, thickness, and shape of adhesives cannot be changed once it drops on the object surface, which has a direct negative impact on the bonding effect between the two surfaces.

### SUMMARY OF THE INVENTION

The problem to be solved in the present invention is to provide a photosensitive adhesive that is convenient to use and featured with high adhesive properties, high air tightness and high weatherability.

The present invention provides a photosensitive adhesive comprising a composition of 0.1 portion to 1 portion by weight of photo initiator; 0.1 portion to 3 portions by weight of organic silicone; 10 portions to 32.5 portions by weight of isocyanate; 10 portions to 32.5 portions by weight of hydroxyethyl terminated polysiloxane; 10 portions to 32.5 portions by weight of polycarbonate diol; 5 portions to 17.5 portions by weight of hydroxyethyl acrylate; 0.01 portion to 0.5 portion by weight of catalyst; and 0.01 portion to 0.5 portion by weight of polymerization inhibitor.

Typically, the photo initiator is any one or two compounds selected from (2, 4, 6-trimethylbenzylidene) diphenylphosphine oxide, bis (1-(2, 4-ditluorophenyl)-3-pyrrolidinyl) dicenelocene or 1-hydroxycyclohexyl phenyl ketone.

Typically, the organic silicone comprises at least two compounds selected from methyltrichlorosilane, dimethyldichlorosilane, phenyltrichlorosilane, diphenyldichlorosilane or methylphenyldiehlorosilane.

Typically, the catalyst comprises at least one compound selected from acidic resin, toluenesulfonic acid., monosulfate, disulfate or p-toluenesulfonic acid.

Typically, the polymerization inhibitor comprises at least one compound selected from methylhydroquinone, P-hydroxyanisole, 2-tert-butylhydroquinone or quinol.

Typically, the photosensitive adhesive further comprises 0.1 portion to 3 portions by weight of an organic pigment.

Typically, the method for making the photosensitive adhesive, comprising the steps of:

(a) adding isocyanate, hydroxyethyl terminated polysiloxane, polycarbonate diol and hydroxyethyl acrylate into a container according to pre-determined portions by weight, and then adding photo initiator into the container;

(b) heating up the container at a preset temperature in a first preset time period; stirring the mixture of compounds inside the container in a second preset time period;

(c) adding organic silicone, catalyst and polymerization inhibitor into the container according to pre-determined portions by weight, and then stirring the mixture of compounds inside the container in a third preset time period; and

(d) cooling.

Typically, the preset temperature is between 60 C and 100° C., the first preset time period is between 1 hour and 2 hours.

Typically, the second preset time period is between ¼ hour and ¾ hour.

Typically, the third preset time period is between ⅓ hour and ⅔ hour.

Typically, the method further comprises the steps of:-

(a) stirring the mixture of compounds inside the container in the third preset time period;

(b) adding the organic pigment to the container according to a pre-determined portions by weight before standing for cooling; and

(c) stirring the mixture of compounds inside the container in a fourth preset time period.

Typically, the fourth preset time period is between 1/20 hour and 1/10 hour.

The photosensitive adhesive provided by the present invention is a paste not sticky to hands. It solves the problem that the traditional liquid UV adhesive is sticky to hands, thus bringing convenience and improving efficiency. The introduction of silicon-modified photo-curing monomers improves the refractive index of the adhesive layer, and the introduction of an appropriate proportion of base resin improves the toughness of the adhesive layer, and offsets the brittleness brought about by the introduction of silicon-modified photo-curing monomer with a high refractive index. So the adhesive layer has both a high refractive index and a good toughness. This is different from traditional UV adhesives. For traditional UV adhesives the increase of the refractive index will harden the adhesive layer, resulting in pulverization during use. Moreover, the photosensitive adhesive provided by the present invention does not flow during use or operation, in addition to its good adhesion, which is different from the traditional liquid UV adhesive. Its pasty state makes it possible to change the size, thickness and shape of adhesive according to actual needs after the adhesive is bonded to the objects before photocuring. This property makes operation more flexible. Furthermore, the photosensitive adhesive provided by the present invention can be added with organic pigments according to actual needs, making it more suitable for more applications.

### DESCRIPTION OF EMBODIMENTS

The technical features of the present invention will be further described below with reference to the embodiments of the present invention.

As listed in the following table, components used in the embodiments are (unit: portions by weight):

TABLE 1
Proportions of components in embodiments

| | Embodiments | | | | | | | | |
|---|---|---|---|---|---|---|---|---|---|
| Components | 1 | II | III | IV | V | VI | VII | VIII | IX |
| Photo initiator | 0.1 | 10 | 8.5 | 9 | 7 | 5 | 6 | 4 | 3 |
| Organic silicone | 0.1 | 3 | 3 | 2 | 1.5 | 1 | 2.5 | 0.5 | 3 |
| Isocyanate | 32.5 | 10 | 25 | 31 | 27 | 28 | 32.2 | 31.5 | 15 |
| Hydroxyethyl terminated | 32.5 | 26 | 20 | 30 | 32 | 23 | 15 | 13 | 31 |
| polysiloxane | | | | | | | | | |
| Polycarbonate diol | 29.78 | 32.5 | 25 | 10 | 21 | 32 | 31 | 32.5 | 31 |
| Hydroxyethyl acrylate | 5 | 17.5 | 17.5 | 14.5 | 11 | 8 | 12 | 15 | 13 |
| Catalyst | 0.01 | 0.5 | 0.5 | 0.25 | 0.3 | 0.4 | 0.1 | 0.2 | 0. |
| Polymerization inhibitor | 0.01 | 0.5 | 0.5 | 0.25 | 0.1 | 0.4 | 0.2 | 0.3 | 0.5 |
| Organic pigments | — | — | — | 3 | 0.1 | 2.2 | 1 | 3 | 3 |

In respect of various conditions of the embodiments, the photo initiator can be any one or two compounds selected from (2, 4, 6-trimethylbenzylidene) diphenylphosphine oxide, bis (1-(2, 4-difluorophenyl) -3-pyrrolidinyl) dicenelocene or 1-hydroxycyclohexyl phenyl ketone. The organic silicone comprises at least two compounds selected from methyltrichlorosilane, dimethyldichlorosilane, phenyltrichlorosilane, diphenyldichlorosilane or methylphenyklichlorosilane. The isocyanate can be selected from toluene diisocynate, diphenylmethane diisocyanate, hexamethylene diisocyanate, isophorone diisocyanate, dicyclohexyl methane diisocyanate, xylylene diisocynate, hexamethylene diisocynate, or polyaryl polymethylene isocyanate. The hydroxyethyl terminated polysiloxane can be selected from hydroxyl terminated polydimethylsiloxane, hydroxyl terminated ethyl polysiloxane, hydroxypropyl terminated polysiloxane, bis [3-(1-methoxy -2-hydroxypropoxy) propyl] terminated polysiloxane, or bis-hydroxypropyl terminated polysiloxane. The hydroxyethyl acrylate can be selected from methyl acrylate, ethyl acrylate, methyl methacrylate, butyl acrylate, hydroxyethyl acrylate, or hydroxyethyl methylacrylate. The catalyst comprises at least one compound selected from acidic resin, toluenesulfonic acid, monosulfate, disulfate or p-toluenesulfonic acid. The polymerization inhibitor comprises at least one compound selected from methylhydroquinone, P-hydroxyanisole, 2-tert-butylhydroquinone, or hydroqui none. Each embodiment is prepared by the following methods according to the portions by weight described in Table 1:

S1: adding isocyanate, hydroxyethyl terminated polysiloxane, polycarbonate diol and hydroxyethyl acrylate into a container according to pre-determined portions by weight, and then adding photo initiator into the container, forming a pasty state;

S2: heating up the container at a preset temperature in a first preset time period, wherein the preset temperature is between 60° C. and 100° C., and the first preset time period is between 1 hour and 2 hours;

S3: stirring the mixture of compounds inside the container in a second preset time period, wherein the third preset time period is between 20 minutes and 40 minutes.

S4: adding organic silicone, catalyst and polymerization inhibitor into the container according to pre-determined portions by weight, and then stirring the mixture of compounds inside the container in a third preset time period, wherein the third preset time period is between 3 minutes and 10 minutes;

S5: cooling.

Preferably, in the embodiments, the following step can be added at the time after the step of S4 and before the step of S5 in order to manufacture adhesives containing different colors.

S5′: adding the organic pigment to the container according to pre-determined portions by weight, and stirring the mixture of compounds inside the container in a fourth preset time period, wherein the fourth preset time period is between 3 minutes and 10 minutes;

TABLE 2
Reaction condition of each embodiment

| | Embodiments | | | | | | | | |
|---|---|---|---|---|---|---|---|---|---|
| | I | II | III | IV | V | VI | VII | VIII | IX |
| | Preset temperature/°C. | | | | | | | | |
| | 60 | 75 | 70 | 75 | 80 | 85 | 90 | 95 | 100 |
| The first preset time | 2 | 1.9 | 1.8 | 1.7 | 1.6 | 1.5 | 1.4 | 1.2 | 1 |
| period/hour | | | | | | | | | |
| The second preset time | 0.25 | 0.3 | 0.4 | 0.45 | 0.5 | 0.55 | 0.6 | 0.65 | 0.75 |
| period/hour | | | | | | | | | |
| The third preset time | 0.33 | 0.4 | 0.45 | 0.5 | 0.5 | 0.55 | 0.55 | 0.6 | 0.67 |
| period/hour | | | | | | | | | |
| The fourth preset time | — | — | — | 3 | 4 | 5 | 6 | 7 | 10 |
| period/hour | | | | | | | | | |

The photosensitive adhesive being made in the embodiments is not slippery and sticky to user's hands when use, because it is in a pasty state. As such, its pasty state of the photosensitive adhesive is adapted for allowing the change of its size, thickness and shape of adhesive according to actual needs of the user during the time that the adhesive is bonded on to the objects before photocuring process. The physical characteristics of the embodiments of the present invention solves the technical problem of the UV adhesive of the existing technology that the existing UV adhesive is a liquid state which is sticky to the user's hands and therefore the existing UV adhesive is very inconvenient when use.

The major materials to be applied in the present invention are isocyanate and hydroxyethyl terminated polysiloxane. In the preparation of polycarbonate diol, the organic silicone and hydroxyethyl acrylate are added, which can. improve the resistance to high temperature and weatherability during the curing process. The addition of silicon-modified photo-curing monomers is adapted to increase the refractive index of the adhesive layer of the present invention. Further, the addition of pre-determined proportion of base resin can increase the toughness level of the adhesive layer of the present invention, and offsets the negative effect of brittleness due to the addition of silicon-modified photo-curing monomer with a high refractive index. As a result, the adhesive layer has both high refractive index and toughness characteristics. Apparently, the photosensitive adhesive of the present invention has technical improvements compared with the UV adhesives of the existing technology. Particularly, when increasing the refractive index of the UV adhesive of the existing technology, the related adhesive layer will harden, resulting in pulverization during use. By contrast, the photosensitive adhesive of the present invention solves the above technical problem of the existing UV adhesive and can achieve the technical features of high adhesive properties, high air tightness and high weatherability. In a fifth embodiment, the photosensitive adhesive of the fifth embodiment was tested. The photosensitive adhesive being tested in the fifth embodiment comprises isocyanate, hydroxyethyl terminated polysiloxane, polycarbonate diol, hydroxyethyl acrylate, and photo initiator. After about 4-minute period of irradiation under ultraviolet light, the top layer of the photosensitive adhesive completely dries out and then stabilizes, and after that, the photosensitive adhesive completely dries out and then bonds after standing for about 12 hours in the air. The adhesive force after bonding can reach a three of 115N approximately, which meets the requirements in almost all applications of the adhesives for use in construction purpose.

Preferably, the adhesive force of the photosensitive adhesive of the present invention is about 115N. Specifically, the reading of the above-mentioned adhesive force was obtained based on laboratory tests. Particularly, referring to the tests, a SNAS electronic universal tensile tester was used to mount the adhesive to the two opposing ends of a PVC wire. Referring to the experiments, the test results were found that the upper end pulling-out force was 116N and the lower end pulling-out force was 115N.

Furthermore, the photosensitive adhesive of the present invention can be added with different kind of organic pigments to satisfy the user's applications in particular applications of the adhesives which are for use in construction purpose or other purpose. In the circumstances, the photosensitive adhesive will then be more varieties in its physical appearances when use.

The present invention has been described in detail, with reference to the preferred embodiment, in order to enable the reader to practice the invention without undue experimentation. However, a person having ordinary skill in the art will readily recognizes that many of the previous disclosures may be varied or modified somewhat without departing from the spirit and scope of the invention. Accordingly, the intellectual property rights to this invention are defined only by the following claims.

1. A photosensitive adhesive comprising a composition of:
0.1 portion to 1 portion by weight of photo initiator;
0.1 portion to 3 portions by weight of organic silicone;
10 portions to 32.5 portions by weight of isocyanate;
10 portions to 32.5 portions by weight of hydroxyethyl terminated polysiloxane;
10 portions to 32.5 portions by weight of polycarbonate diol;
5 portions to 17.5 portions by weight of hydroxyethyl acrylate;
0.01 portion to 0.5 portion by weight of catalyst; and
0.01 portion to 0.5 portion by weight of polymerization inhibitor.

2. The photosensitive adhesive according to claim 1, wherein the photo initiator is any one or two compounds selected from (2, 4, 6-trimethylbenzylidene) diphenylphosphine oxide, bis (1-(2, 4-difluorophenyl) -3-pyrrolidinyl) dicenelocene or 1-hydroxycyclohexyl phenyl ketone.

3. The photosensitive adhesive according to claim 1, wherein the organic silicone comprises at least two compounds selected from methyltrichlorosilane, dimethyldichlorosilane, phenyltrichlorosilane, diphenyldichlorosilane or methylphenyldichlorosilane.

4. The photosensitive adhesive according to claim 1, wherein the catalyst comprises at least one compound selected from acidic resin, toluenesulfonic acid, monosulfate, disulfate or p-toluenesulfonic acid.

5. The photosensitive adhesive according to claim 1, wherein the polymerization inhibitor comprises at least one compound selected from methylhydroquinone, P-hydroxyanisole, 2-tert-butylhydroquinone or quinol.

6. The photosensitive adhesive according to claim 1, wherein the photosensitive adhesive further comprises 0.1 portion to 3 portions by weight of an organic pigment.

7. The method for making the photosensitive adhesive according to claim 1, comprising the steps of:
(a) adding isocyanate, hydroxyethyl terminated polysiloxane, polycarbonate diol and hydroxyethyl acrylate into a container according to pre-determined portions by weight, and then adding photo initiator into the container;
(b) heating up the container at a preset temperature in a first preset time period;
stirring the mixture of compounds inside the container in a second preset time period;
(c) adding organic silicone, catalyst and polymerization inhibitor into the container according to pre-determined portions by weight, and then stirring the mixture of compounds inside the container in a third preset time period; and
(d) cooling.

8. The method for making the photosensitive adhesive according to claim 7, wherein the preset temperature is between 60° C. and 100° C., the first preset time period is between 1 hour and 2 hours.

9. The method for making the photosensitive adhesive according to claim 7, wherein the second preset time period is between ¼ hour and ¾ hour.

10. The method for making the photosensitive adhesive according to claim 7, wherein the third preset time period is between ⅓ hour and ⅔ hour.

11. The method for making the photosensitive adhesive according to claim 7, wherein the method further comprises the steps of:
(a) stirring the mixture of compounds inside the container in the third preset time period;
(b) adding the organic pigment to the container according to a pre-determined portions by weight before standing for cooling; and
(c) stirring the mixture of compounds inside the container in a fourth preset time period.

12. The method for making the photosensitive adhesive according to claim 7, wherein the fourth preset time period is between 1/20 hour and 1/10 hour.
